(19) United States
(12) Patent Application Publication
(10) Pub. No.: US 2004/0150829 A1
(43) Pub. Date: Aug. 5, 2004

(54) Interferometric arrangement for determining the transit time of light in a sample

(76) Inventors: Peter Koch, Luebeck (DE); Martin Wosnitza, Worpswede (DE)

Correspondence Address: LARSON AND LARSON, 11199 69TH STREET NORTH, LARGO, FL, 33773

(21) Appl. No.: 10/475,040

(22) PCT Filed: Apr. 16, 2002
(86) PCT No.: PCT/DE02/01404

(30) Foreign Application Priority Data
Apr. 17, 2001 (DE) 101 18 760.2

(51) Int. Cl. G01B 9/02

(52) U.S. Cl. 356/477

(57) ABSTRACT

An interferometric arrangement device is used for determining the transit time distribution of light in the sample branch of an interferometer in which the light returning from the reference branch and the sample branch is superimposed, and by means of the intensity distribution of the superimposed light, a transit time distribution of the light in the sample branch is determined. Evaluation takes place by means of the spatial intensity distribution of the superimposed light. The sample and reference light is guided from the sample location to the evaluating device in a common fibre.

### PRIOR APPLICATIONS

This application bases priority on International Application No. PCT/DE02/01404, filed Apr. 16, 2002, which in turn bases priority on German Application No. DE 101 18 760.2, filed Apr. 17, 2001.

### BACKGROUND OF THE INVENTION

1. Field of the Invention

The invention relates to an interferometric arrangement for determining the transit time distribution of light in the sample in accordance with the features given in the preamble of claim 1.

2. Description of the Prior Art

Methods for determining the transit time distribution and corresponding devices form part of the prior art and are e.g. known from DE 199 29 406 A1. They are typically used in optical coherence tomography (OCT). Said method operates in the short wavelength range and in particular in the high infrared spectrum of light and is used for microscopic resolution of surface structures.

The fundamental idea of the known device is to spatially perform the evaluation for determining the transit time distribution of light in the sample branch of an interferometer, namely with the aid of the spatial intensity distribution of the superimposed light.

These devices operate without moving parts and consequently do not require the otherwise conventional phase modulator and the associated constructional, cost and system-based disadvantages. The light returning from the sample branch and reference branch of the interferometer enters the evaluating unit at two different locations in which it is spatially superimposed. The transit time distribution of the light in the sample branch is determined by means of the spatial intensity distribution in said superimposed area.

If, as is desired, the equipment structure of the interferometer is such that the light is essentially guided in light waveguides, the two punctiform exit locations, after leaving the fibre (monomode fibre), are automatically obtained, i.e., the end of the light waveguide forms two virtual point light sources which merely have to be arranged in such a way that there is a superimposition area.

To simplify evaluation, the outputs of the light waveguide are frequently followed by a cylindrical lens, which focuses the conical light exit in a fan-shaped form substantially in a single plane, and in which is then located a photo detector line as a detector. For the OCT method, working takes place with a broad-band short coherence length light source. The light of said source, in a Michelson interferometer, is split into a first beam part which covers a constant distance up to the detector, said part of the interferometer being called the reference branch, as well as into a second part which radiates onto the sample to be examined, is reflected or back-scattered by the latter so that as a function of the reflection layer depth the distance traversed is different, as is the transit time of the light to the detector. Both parts are guided and superimposed at two spatially remote locations for forming a Gaussian beam diameter reduction. As a function of the transit time distribution there is a differing intensity distribution over the detection axis. There is typically a Gaussian intensity distribution along the superimposition area of the light.

A comparable interferometric arrangement is known from DE 197 32 619 C2, where structural designs of optical detectors are described in a comparative manner. However, in the latter case in the measuring channel, which corresponds to the aforementioned sample branch, it is not the light reflected by the sample, but the light which has transilluminated the sample which is used for superimposing with the reference branch light. Such an arrangement is e.g. appropriately used for determining the refractive indices of different substances.

The known arrangements suffer from disadvantages, which are to be eliminated by means of the present invention.

In the devices used up to now the reference light and the sample light are led in different ways to the evaluating device. If the light waveguide in which the light is guided is exposed to different environmental influences, such as mechanical stresses or temperatures, there are changes to the transit paths of the sample and reference light, and this also takes place in a different way. Such differential changes cannot be differentiated by the detector as compared with true movements of the sample, and consequently, the measured result is falsified.

Different stresses on the light waveguides in which the samples and reference light are guided lead to different stress-induced double refractions. If static, this effect only deteriorates the resolving power of the device. If the stress states of the fibres change dynamically there are even fluctuations in the signal levels and positions during the measurement. Such dynamic changes are unavoidable if the sample fibre is moved, which is the case in virtually all medical applications of the technology.

As a result of the system, the known devices have to use a reference arm. Measurements of the transit time distributions in the sample consequently always take place relative to the transit time in the reference arm. However, the situation is frequently such that there is no interest in the position of the sample relative to the reference length and instead only specific structures in the sample are to be investigated. In such cases, the known devices suffer from the disadvantage that any sample movements deteriorate the measured result.

In the conventional Michelson interferometer arrangements, the reference light leaves the fibre in order to be reflected back into the same by a mirror. These arrangements suffer from the disadvantage that there are losses at the mirrors and on coupling into the fibre again.

As described hereinbefore, in the observation plane there is a summation of the two Gaussian intensity distributions, which occur following the exit of the sample and reference light from the fibre ends. The image sensors used have significant sensitivity differences between the different pixels. These errors, and errors when determining the modulation amplitudes, are typically compensated in that the measured data obtained are multiplied with calibration values. However, this is only possible to a limited extent if the background intensities during the measurement change, e.g. because in the sample measurement has occurred of one point with a particularly high reflectivity.

Therefore the problem of the present invention is to so construct an interferometric arrangement according to the preamble that the problems indicated hereinbefore are avoided or at least reduced. According to the invention this problem is solved by the features of claim 1. Advantageous developments of the invention are given in the subclaims, the following description and the drawings.

### SUMMARY OF THE INVENTION

The fundamental idea of the present invention that the sample, either by reflection or by transillumination, superimposes quasi with itself returning light in that the light returning from the sample is split into two parts, which are then superimposed and supplied to an optical detector. This fundamental, novel idea implemented with the invention is to combine the light back-scattered from the sample at the sample location with light from an optionally reference plane, so that both parts are guidable jointly in a single light waveguide to the evaluating unit. The light guided in the fibre is divided there into two parts, which subsequently exit the fibres in this way. The exit locations or fibre ends are so positioned that the two resulting light cones overlap.

Interference phenomena occur in the overlap area and can be used for determining the transit time distribution in the sample. Generally the interference phenomena are of a very complex nature. The amplitudes of the interferences are composed of three different items, namely the interferences of the reference light with itself, the sample light with itself and the sample light with the reference light. All the three parts are arranged symmetrically about z=0 (z corresponds to the wavelength difference between samples and reference arm).

At the location z=0 there is a high Gaussian part. It corresponds to the autocorrelated part of the reference light. If in the reference only a single wavelength is allowed, said part corresponds to the coherence function of the light source.

The second part is the autocorrelated part from the transit time distributions in the sample. If there is no reference intensity only this part is measured. Thus, the position of this part in the interferogram is also not dependent on the absolute position of the sample, which is very advantageous for certain applications. This part cannot be measured in the prior art arrangements.

The third part corresponds to the cross-correlation between the sample light and the reference light. This part occurs symmetrically on both sides of the interferogram. It is the only part which is measurable with the prior art methods. The devices used in the interferometric arrangement according to the invention can differ as a function of the intended main use.

In order to overcome considerable distances between the sample and detector, and in particular, largely eliminate thermal influences, an arrangement is advantageous in which the illumination arm admittedly also issues into a beam splitter, preferably a first fibre coupler, which proportionally conducts the light into the sample branch and the reference branch, but which is constructed in such a way that the light is reflected both in the sample branch and the reference branch, returns to the beam splitter, and from there is guided by means of a common light waveguide to a further second beam splitter which can be positioned remotely. Said second beam splitter supplies two light waveguides with, in each case, an exit and associated with the detector. Thus, unlike in the prior art, in this arrangement the reference and sample branches are combined in a common light waveguide so that the bridging of greater distances is possible, and at least in this area, the device is largely insensitive to thermal influences because during both expansion and contraction, the lengths of the reference and sample branches change in the same way and consequently do not influence the measured result. The arrangement can be such that the reference branch has a mirror or the corresponding end of the light waveguide is used as a reflecting surface in order to return the light in the reference branch to the beam splitter. Whereas, in the sample branch this takes place through the sample.

Alternatively, also in this area the light can be jointly guided in the reference and sample branches, if either for the reference branch a semi-reflecting mirror is positioned in the area upstream of the sample or the sample has at least two different surfaces for reflection purposes and then the light reflected on one of these surfaces serves as the reference branch light.

In order to further increase the light intensity within the arrangement, the first beam splitter is preferably formed by a circulator, which directs the light onto the sample and receives the light reflected by the sample, passing it on towards the detector.

Preferably, the reference and/or sample branch contain a calibrating arrangement, i.e., for the optionally necessary compensation of different lengths. It is e.g. possible to use a static phase modulator which has no or at least no dynamic drive.

The structure of the arrangement according to the invention can be such that with the exception of a small area between the light waveguide and the entry of the sample branch and the sample, the light is closed in the complete arrangement and is substantially exclusively guided in light waveguides so that the arrangement is largely insensitive to environmental influences, particularly dust and vibrations.

In addition, besides or as an alternative, in the reference branch means are provided for reducing the light intensity e.g. grey filters or the like, in order to at least roughly match the intensity of the light in the reference branch to that of the sample branch.

It is favourable to determine the intensity of the superimposed light line wise instead of aerially, e.g. by means of a cylindrical lens which flat focuses the exiting light beams. The photo detector line can fundamentally be a random series of photosensitive cells, such as e.g. a photodiode line, a CCD line or the like. It is particularly advantageous as regards costs, measuring errors and measuring dynamics, to use a MOS line sensor, the spacing of the detection cells being preferably chosen in such a way that the centre spacing corresponds to a third of the middle wavelength of the light. It is then possible to bring about a reliable detection without knowing the phase position of the light or the intensity distribution. Optionally, the spacing of the detector cells can be further increased if account is taken of information concerning the phase position or the resolution is reduced (under sampling).

The analog output signal of the detector, particularly the MOS line sensor, can be further processed in both analog, digital and analog-digital manner. It has proved to be particularly favourable to initially process the output signal in analog manner and within the evaluating device in order to reduce a predetermined value, and then optionally spread the same. If this is followed by an analog-digital converter, the latter can have a lower measurement resolution without influencing the precision of the measured result. However, it must always be ensured that the detector output signal is always above the value by which the signal is reduced within the evaluating device during analog processing.

### DESCRIPTION OF THE DRAWINGS

The invention is described in greater detail hereinafter relative to embodiments and the attached drawings, wherein show:

FIG. 1 Diagrammatically interference at the Young's two slit.

FIG. 2 An intensity distribution as is typically measured with a MOS line sensor.

FIG. 3 A diagrammatic side view of the beam path between the light waveguide and the detector.

FIG. 4 The beam path according to FIG. 3 in plan view.

FIG. 5 Diagrammatically a first embodiment of the invention.

FIG. 6 Diagrammatically a second embodiment of the invention.

FIG. 7 Diagrammatically a third embodiment of the invention.

FIG. 8 Diagrammatically a fourth embodiment of the invention.

FIG. 9 A block diagram of digital signal processing in the evaluating device.

FIG. 10 A block diagram of an analog signal processing of the evaluating device.

### DETAILED DESCRIPTION OF THE PREFERRED EMBODIMENT

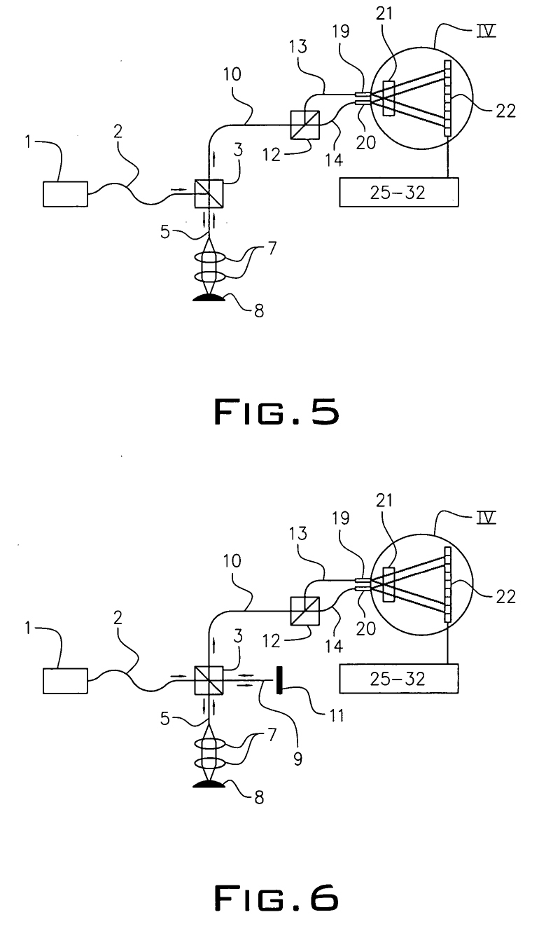

The embodiments illustrated by means of FIGS. 5 to 8 and showing the devices according to the invention have in common a broad-band light source 1 with a short coherence length feeding into an interferometer arrangement. The light emanating from the light source 1 passes via a light waveguide 2 to a first beam splitter 3 in the form of a fibre coupler. As is conventional in such applications, single mode fibres constitute the light waveguides.

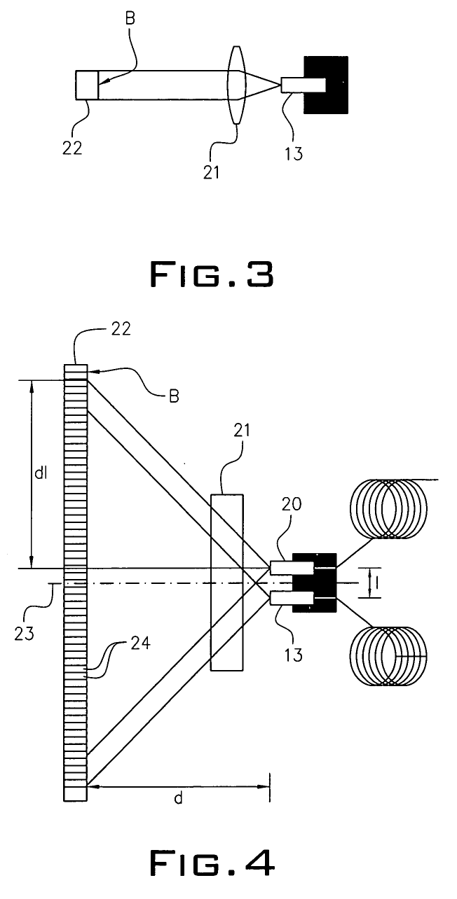

The light leaving the output-side light waveguide 5 of the fibre coupler 3 is focussed by means of optics 7 on a sample 8 to be examined. The light leaving the light waveguide 5 passes through the optics 7 and is focussed on sample 8, where it is at least partly reflected by optics 7 and passes back into the light waveguide 5. From there it passes via a light waveguide 10 emanating on the input side from the beam splitter 3 and in parallel to the light waveguide 2 to a second beam splitter 12, also in the form of a fibre coupler. In this arrangement the second output-side fibre end of the fibre coupler 3 is unused, as is the second input-side end of the fibre coupler 2. The two output-side ends 19, 20 of the light waveguides 13, 14 of fibre coupler 12 are guided in an optical arrangement IV, as described in detail hereinafter relative to FIGS. 3 and 4. In the case of the above-described interferometric arrangement there is no reference path, as is the case in comparable prior art arrangements, and instead, here a reflection plane of the sample is used as the reference plane so that samples and reference branch traverse the same optical path, apart from the different wavelengths in the sample.

In the arrangement according to FIG. 6, in the same way as described hereinbefore, light of a broad-band light source 1 e.g. a light emitting diode having a short coherence length, passes through the light waveguide 2 to a beam splitter 3 in the form of a fibre coupler. The light is passed in both a light waveguide 9 and a light waveguide 5. The light waveguide 5 forms the part of the sample branch where the light exits through optics 7, is focussed on sample 8 and reflected there, and reflected back into the light waveguide 5. The light waveguide 9 forms part of the reference branch. The light passed through it is reflected at the end by means of a mirror 11 or a mirrored end face, and then once again passes to the beam splitter 3. Part of the reflected light of the sample and reference branches passes in unused form into the light waveguide 2, whereas, the other part passes to the light waveguide 10 connected to the fibre coupler 3 at the side of the light source 1, and which is connected to a second beam splitter 12, also in the form of a fibre coupler. The light waveguide 10 between the beam splitters 3 and 12 is both part of the sample branch and the reference branch, which are combined in this region of the device. The second beam splitter 12 splits the light guided in the light waveguide 10 into two beam parts which are guided in the light waveguides 13 and 14, whose ends are located in an arrangement IV, which is described in detail hereinafter.

It is desirable for evaluation purposes to have equal light intensities in both the sample and reference branches. As in the variant according to FIG. 6, the reference light is almost completely reflected at mirror 11. It is appropriate to provide inwardly swingable grey filters in the vicinity of the light waveguide 9 or between the latter and the mirror, and they are able to reduce the light intensity within said arm in order to arrive at a roughly identical intensity level to that in the sample branch.

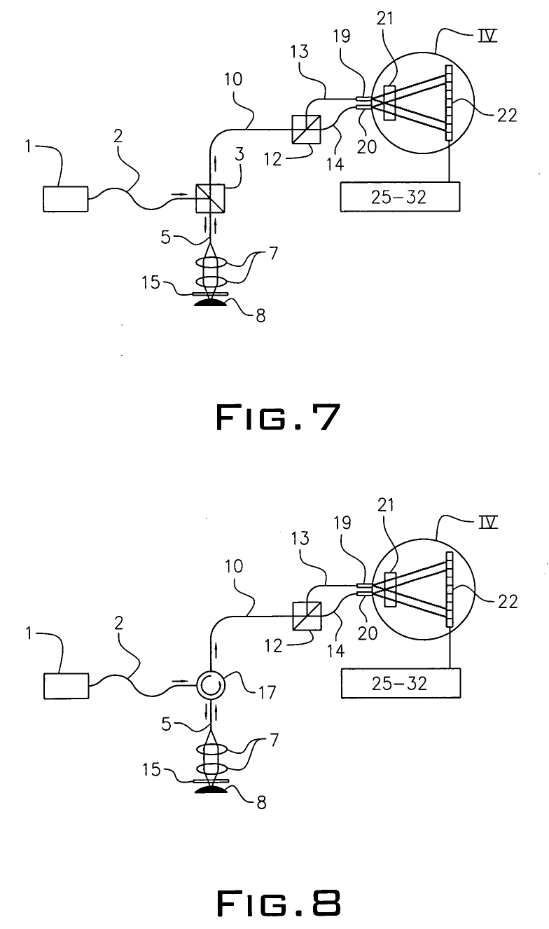

The arrangement according to FIG. 7 differs from that described hereinbefore in that between the optics 7 and sample 8 is provided a semi-reflecting mirror 15 so that part of the light is reflected thereon, and another part at the sample 8 so that transit time differences arise which can be evaluated at the end within arrangement IV. The light reflected at mirror 15 here forms the reference branch, whereas, that reflected at the sample 8 forms the sample branches which are superimposed over the entire light waveguide path.

The embodiment according to FIG. 8 has its structure fundamentally the same as that according to FIG. 7 with the difference that the first beam splitter 3 is replaced by a circulator 17. The light leaving the light source 1 passes in the embodiment according to FIG. 8 via a light waveguide 2 into the circulator 17, and exits via light waveguide 5 to sample 8 where it is focussed in the same way by means of an objective 7, which passes through a semi-reflecting mirror 15 and finally strikes the sample. The light reflected by the mirror 15 and which forms the reference branch, as well as the light reflected by the sample 8 which forms the sample branch, passes once again through the objective 7 into the light waveguide 5, and from there into the circulator which supplies said superimposed light to a light waveguide 10 which leads, as in all the previously described embodiments, to the second beam splitter 12 and the evaluating arrangement IV. As a result of the circulator, in this arrangement there is a lower loss light guidance.

In addition, the previously described devices in accordance with FIG. 6 are preferably provided in the vicinity of the light waveguide 9 (reference branch) with a calibrating element which makes it possible to adapt the path of the light in the reference branch to that in the sample branch or to modify the path in the reference and sample branches. For this purpose it is e.g. possible to use a phase modulator.

In order to determine the transit path differences of the light between the reference and sample branches by means of arrangement IV, interferences are produced which lead to intensity differences of the light over the surface area, which are spatially determined, so as in this way to establish the transit time distribution, and therefore, in particular, the transit path differences between the sample and reference branches. The starting point of the arrangement IV are the contexts and connections which result from the phenomenon known in the literature as the Young's two slit experiment. If, as is shown in FIG. 1, two coherent light sources are positioned at a distance d from one another in such a way that both assume the distance D from an observation plane B, on the latter, interference phenomena occur. If the distance D is much larger than the distance d, the path length difference between the two light sources can be described as follows:

$$δ = L1 - L2 = Δ L = \frac{d}{D} \cdot x$$

The two light sources, in accordance with the two slit experiment, being replaced by a light source with a following double slit with the spacing d. The path length L1 represents the path length between the first slit up to a point P on the observation plane L2, the path length from the second slit to said point P, x representing the distance from point P to the centre axis between the two slits.

Constructive interference occurs at all points xₘ where the wavelength difference between the slits is an integral multiple of the wavelength of the light:

$${x}_{m} = \frac{d}{D} \cdot m \cdot λ$$

This effect is utilized by arrangement IV, where in place of the double slit use is made of the outputs of light waveguides 13 and 14, which are so arranged with the spacing d that the above-described interference effect occurs. The monomode light waveguides represent Gaussian beam diameter reductions, i.e., the light emanating from the fibre ends in the lateral direction has a Gaussian intensity profile. In addition, there is a widening of the light bundle with increasing distance from the fibre with numerical aperture of the light waveguide. The two fibre ends are positioned in such a way that there is a significant overlap of the resulting beam cones. The coherent parts interfere with one another in this overlap area. The different light intensities over the observation surface occurring due to the interference phenomena are bundled on an observation line, in that ends 19, 20 are followed by a cylindrical lens 21 which is in turn followed at a suitable distance d by a line camera 22 as a detector.

The spatial intensity distribution of the light along the axis of the line camera 22 is as follows:

I_{M}=I_{P}+I_{R}+2.γ.\sqrt{I_{P}.I_{R}}.cos(2.π.x)

In which IP is the intensity of the light in the sample branch, IR the intensity of the light in the reference branch, x the distance to the centre line 23 between ends 19 and 20, and γ the coherence function of the light.

In order to be able to reliably determine the resulting intensity differences with respect to the spacing and number of individual sensors, the line camera 22, which is constructed as a MOS line sensor, is built up in such a way that the spacing of the centres of the sensors 24 is smaller than a third of the median wavelength of the light emanating from the light source 1.

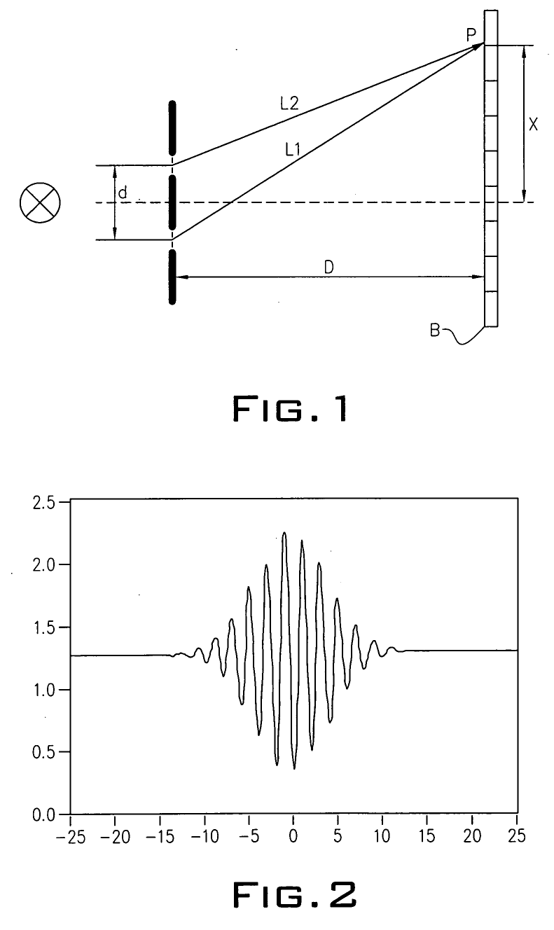

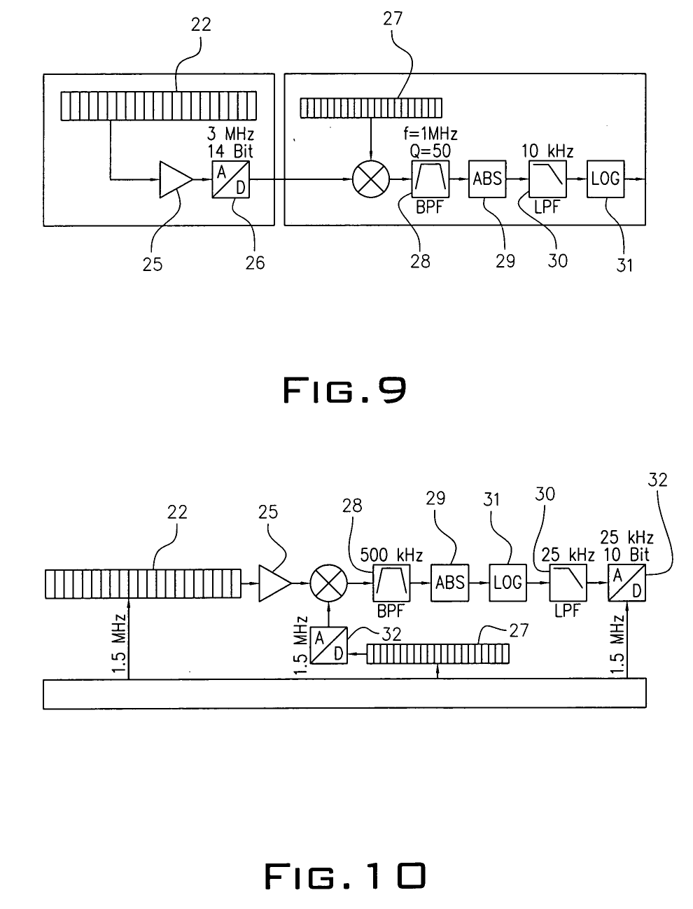

The intensity distribution shown in FIG. 2 occurs with the same transit time distribution of the light in the sample and reference branches, i.e., with the same length. The sample branch length is dependent on the surface area of the sample at the scanned point. Length changes consequently arise as a displacement of the enveloping Gaussian curve of FIG. 2 to the right or left of the origin, the displacement being a direct measure for the transit time distribution in the reference and sample branches, and therefore. for the length change of the sample branch with respect to the reference branch as a function of the middle wavelength of the light used. The processing of the electric signal emanating from the line camera 22 is shown in FIGS. 9 and 10, FIG. 9 showing an evaluating device with substantially digital signal processing, and FIG. 10, as such, a device with analog signal processing. The data read out from the line sensor 22 are initially amplified by means of an amplifier 25 and converted into voltage values. The amplifier 25 is followed by an analog-digital converter 26. For a data rate roughly corresponding to that attainable with a time-resolved OCT, it is e.g. possible to use a 3 MHz converter. The data processed at the output of the analog-digital converter 26 can be digitally further processed, as is known per se with time-resolved OCT equipment. Firstly, systematic errors are removed from the data, and in particular, those resulting from different pixel sensitivity. For this purpose, the individual measured values of each sensor 24 of the sensor line 22 are linked with previously determined correction factors stored in a memory 27, and are then filtered in a bandpass filter 28 in order to minimize interfering noise components. The signal is then demodulated in that it is firstly supplied to a rectifier 29 and then a low pass filter 30, and is finally logarithmated in order to permit representation over several orders of magnitude.

If the data read from the sensor line 22 are directly digitized as described hereinbefore, it must take place with a digitization rate which is roughly twice the carrier frequency. Moreover, in this case, a digitization depth of approximately 14 bit is required.

To this extent, it is more favourable to initially process the measured data obtained in analog form in order to minimize the demands on the A-D converter. For this purpose, the spatial information present on the image sensor are converted back in time-continuous manner, in that all the sensors 24 of the line sensor 22 are read out with a specific frequency. A signal obtained in this way can be filtered by means of a bandpass filter, rectified, logarithmated and smoothed, as is conventional with standard time-resolved OCTs. For digitizing the thus obtained signal, it is sufficient to have an 8 bit converter which is timed with 5% of the carrier frequency.

However, a problem is that the sensitivity differences of the individual sensors 24 can no longer be digitally removed. The corresponding calibration values can, however, in digitized form be stored in a ROM unit 27, converted back by a digital-analog converter 32 into analog signals, and multiplied with the measured values from the associated image sensor 24. A converter precision is adequate which corresponds to the reciprocal of the uniformity fluctuation multiplied by the necessary converter resolution in the case of direct digitization.

The preceding description has characterized the fundamental structure of the device. It is obvious that as a function of the intended use, the individual components will be correspondingly varied or selected. All the above-described embodiments have the major advantage that the light is jointly guided from the reference and sample branches in the vicinity of the light waveguide 10 so that optionally here considerable distances can be bridged without having to accept disadvantages with respect to the long term stability. The embodiment according to FIG. 8 is admittedly more costly as a result of the circulator 17 used, but this leads to a much higher light efficiency which increases the dynamics.

If e.g. with an OCT device with the aforementioned structure it is necessary to determine a depth measurement area of the sample of 15 æm, generally a measuring range of 70 æm is sufficient to perform practicable measurements. Such measurement depths are e.g. necessary for measuring galvanically produced structures of semiconductors. If the light source is constituted by a super-light emitting diode with a median wavelength of 830 nm, in the case of a spacing of the individual image points of the sensor of one third of the wavelength, e.g. a CMOS line sensor with 512 elements can be used where each photosensitive cell e.g. has a size of 25×2500 æm. If a distance of 2.5 mm is adopted between the outputs 19 and 20 of the light waveguide guiding the light returning from the sample and reference branches, the observation plane B must admittedly be located 224 mm from the fibre ends so that for each detector cell there is a third of a wavelength. With such a spacing and an aperture of the light waveguide of 0.11, the intensity drops from the centre of the image sensor to its edge by approximately 80% of the maximum intensity. To ensure that a significant part of the light efficiency does not pass above or below the image sensor, it is possible to position upstream of the fibre ends a cylindrical lens with a focal length of 10 mm and with a spacing of 10 mm. Under these conditions, the light from the fibres is collimated to an approximately 2 mm high bundle so that all the light reaches the 2.5 mm high sensor elements. Evaluation can e.g. take place with a digitizing rate of 100 KHz so that the 512 elements of the image sensor are read 200 times per second. Thus, a depth measurement is theoretically possible of 200 points of the sample every second, and for the point to point displacement of the sample branch optics, it is still possible to calculate a certain time so that this theoretical scanning rate cannot be completely used.

Having thus described the invention, what is claimed and desired to be secured by letters patent is:

1. An interferometric arrangement for determining the transit time distribution of light in a sample having a light source whose light is supplied to a sample to be examined, in which the light returning from the sample is supplied by means of a light waveguide to a detector with downstream evaluating device, and characterized in that the light returning from the sample and guided in the light waveguide is split into two parts which are superimposed and supplied to the optical detector.
